(19) United States
(12) Patent Application Publication
(10) Pub. No.: US 2006/0250271 A1
(43) Pub. Date: Nov. 9, 2006

(54) Muster station and system for emergency communication

(75) Inventor: Larry Zimmerman, Stow, MA (US)

Correspondence Address: Dean D. Small;Armstrong Teasdale LLP, Suite 2600, One Metropolitan Square, St. Louis, MO, 63102, US

(73) Assignee: SimplexGrinnell LP

(21) Appl. No.: 11/391,525

(22) Filed: Mar. 28, 2006

Related U.S. Application Data
(60) Provisional application No. 60/673,604, filed on Apr. 21, 2005.

(51) Int. Cl. G08B 5/22

(52) U.S. Cl. 340/825.36

(57) ABSTRACT

A system for providing emergency communication within a building comprises a command center and muster stations. A command module is located at the command center. Control modules are located at respective muster stations which are located in different areas within the building. At least one communication link provides communication between the command module at the command center and each of the control modules at the muster stations.

### CROSS REFERENCE TO RELATED APPLICATIONS

The application relates to and claims priority from provisional patent application Ser. No. 60/673,604, titled “MUSTER STATION”, filed Apr. 21, 2005, the complete subject matter of which is expressly hereby incorporated herein in its entirety.

### BACKGROUND OF THE INVENTION

This invention relates generally to communication between people in a building during an emergency situation, and more particularly, to systems providing communication between building occupants and emergency responders to provide current information and assistance during an emergency situation.

Large buildings such as high rises often have emergency preparedness and disaster plans to assist occupants during an emergency. These plans often are acted on by the occupants with little or no real-time communication and direction from emergency responders. Confusion, panic and chaos may result when an emergency is declared, even though the emergency may not impact people in all areas of the building. For example, a fire on one floor may be contained and thus there is no need to evacuate the entire building. However, people may panic due to a lack of information and exit in a haphazard manner, potentially creating a dangerous situation where too many people attempt to exit using the same stairwell at the same time or use a stairwell which is not safe. Therefore, providing clear, concise, and timely information may save lives and prevent injury.

Buildings often have intercom systems with speakers for relating general information, but it may not be possible to communicate in this manner to people who are out of hearing range or are hearing impaired, or if the message was missed or garbled. Also, intercom systems are one-way and may not be addressable to specific locations or personnel. Phone systems or cellular phone communications may be down or jammed beyond capacity during an emergency, and may not register an origination location. Each call must then be tied to a group of people or a location, information the caller may not be able to communicate accurately. The logistics of organizing and managing this information can quickly overwhelm emergency responders and slows vital communications.

Furthermore, the actual number and locations of people within the building at any one time is typically not known. Tracking and communicating with each person is difficult if not impossible within the limited time the emergency presents. Emergency responders may thus spend unnecessary time ensuring people are out of an area of the building or be hesitant to apply aggressive emergency procedures such as activating fire extinguishing deluge systems until it is confirmed that an area is vacated. Also, emergency responders may arrive at a location without the necessary equipment or tools, resulting in a delayed response.

Therefore, a need exists for quickly collecting emergency situational data to make proper decisions and effectively sharing current and updated information, as well as ensuring the safety and removal of all persons from a building. Certain embodiments of the present invention are intended to meet these needs and other objectives that will become apparent from the description and drawings set forth below.

### BRIEF DESCRIPTION OF THE INVENTION

In one embodiment, a system for providing emergency communication within a building comprises a command center and muster stations. A command module is located at the command center. Control modules are located at respective muster stations which are located in different areas within the building. At least one communication link provides communication between the command module at the command center and each of the control modules at the muster stations.

In another embodiment, a muster station for communicating with a command module at a command center during emergency situations is provided. A control module at a muster station provides communication with a command module located at a command center. A communication link connects the control module at the muster station with the command module at the command center. A communication device communicates through the command module with the command module, providing two-way communication between the command module and the communication device over the communication•link.

In another embodiment, a system for tracking moving objects within an area and communicating emergency information is provided. A command module is located at a command center, and control modules are located at respective muster stations provided within the area. A communication link interconnects the command module at the command center and the control modules at the muster stations, providing communication between the command module and the control modules. Readers detect location information of locator devices and tracking sensors. The readers are connected to the communication link and provide the location information to the command module of the command center over the communication link.

### BRIEF DESCRIPTION OF THE DRAWINGS

FIG. 1 illustrates a system for communicating with and directing groups of people within an area during an emergency situation in accordance with an embodiment of the present invention.

FIG. 2 illustrates an integrated system for monitoring events and communicating emergency information in accordance with an embodiment of the present invention.

FIG. 3 illustrates a muster station in accordance with an embodiment of the present invention.

FIG. 4 illustrates an emergency communication and tracking system within the building using the system of FIG. 2 in accordance with an embodiment of the present invention.

FIG. 5 illustrates a portion of the emergency communication and tracking system of FIG. 4 in accordance with an embodiment of the present invention.

The foregoing summary, as well as the following detailed description of certain embodiments of the present invention, will be better understood when read in conjunction with the appended drawings. The figures illustrate diagrams of the functional blocks of various embodiments. The functional blocks are not necessarily indicative of the division between hardware circuitry. Thus, for example, one or more of the functional blocks (e.g., processors or memories) may be implemented in a single piece of hardware (e.g., a general purpose signal processor or a block or random access memory, hard disk, or the like). Similarly, the programs may be stand alone programs, may be incorporated as subroutines in an operating system, may be functions in an installed software package, and the like. It should be understood that the various embodiments are not limited to the arrangements and instrumentality shown in the drawings.

### DETAILED DESCRIPTION OF THE INVENTION

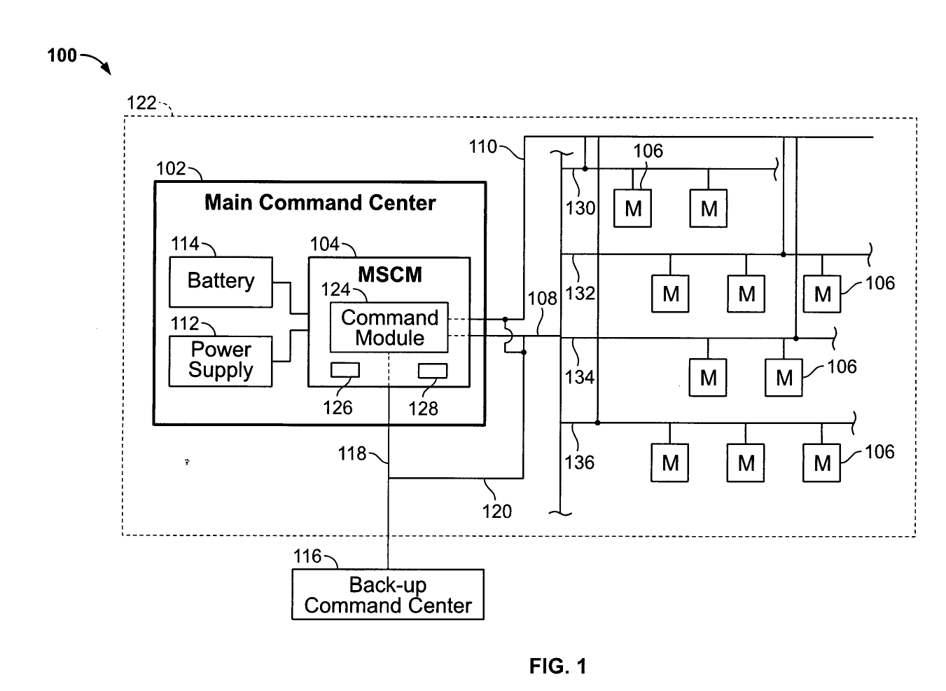

FIG. 1 illustrates a system 100 for communicating with and directing groups of people within an area during an emergency situation. In a large facility, such as a high-rise, it is easier and more efficient to communicate with, provide direction to, and manage the safety of groups of people rather than individuals. By instructing people to muster at specific locations, such as muster stations 106 which are located within the building, individuals may be quickly grouped and provided with the communications, information, and materials to react to the emergency which reduces the risk to the building's occupants and the emergency responders. The term emergency responder may be used to refer to fire fighters, police officers, building safety personnel, paramedics, medical personnel or any other person who provides aide and assistance during the emergency situation.

The system 100 may be installed in a multi-floor building 122 such as a high rise, to provide information and emergency services to people based on their needs and/or location within the building 122. A main command center 102 may be located within the building 122 to provide a central location for monitoring alarms, receiving and disseminating information, and responding to emergencies related to natural and man-made incidents such as an earthquake, fire, bombs, chemical spills, heart attack, personal injury, and the like. Alternatively, the main command center 102 may be located remote from the building 122.

A muster station control module (MSCM) 104 is located within the main command center 102. A power supply 112 provides one or more levels of voltage to supply power to the MSCM 104 and first and second communication links 108 and 110. The power supply 112 may be an AC branch circuit. One or more batteries 114 provide a back-up power source in the event of a failure of the power supply 112.

The MSCM 104 has a command module 124 which provides control software and hardware to operate the system 100. An input/output (I/O) port 128 allows communication with external devices such as a laptop computer, personal digital assistant, telephones, and pager. Alternatively, the MSCM 104 may have wireless capability, allowing wireless communication between the MSCM 104 and the external device.

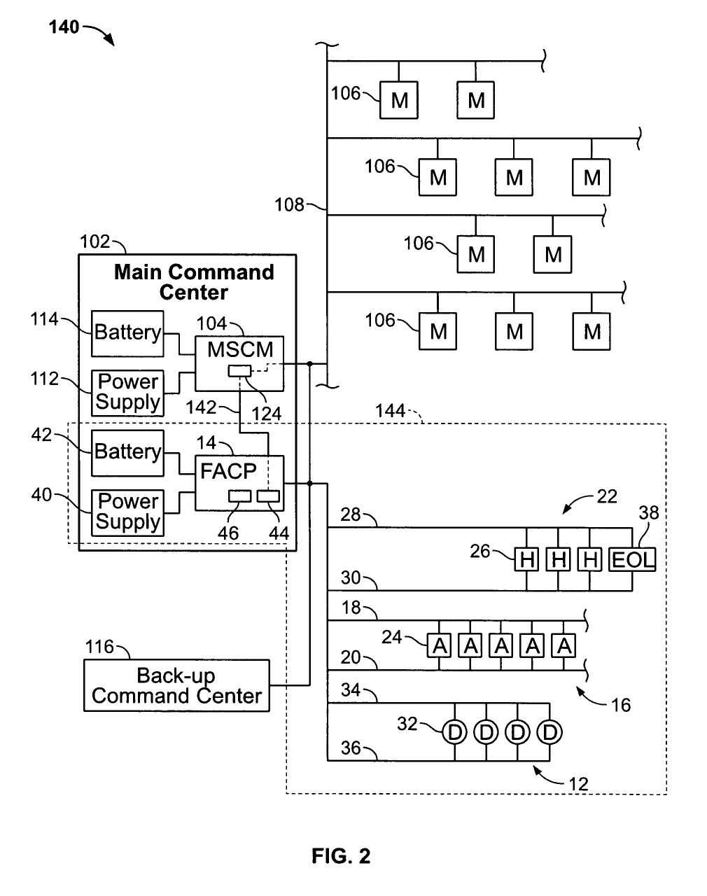

One or more displays 126 may be provided for displaying the status of the system 100 or components of the system 100. Displays 126 may also be used to track people and equipment, and to provide integrated information from additional systems, such as an alarm detection system (FIG. 2). The displays 126 may provide an indication when a muster station 106 is initiating communication, such as one or more lights, alpha-numeric displays, a screen, or a touch screen, allowing an emergency responder to quickly select and establish communication with the muster station.

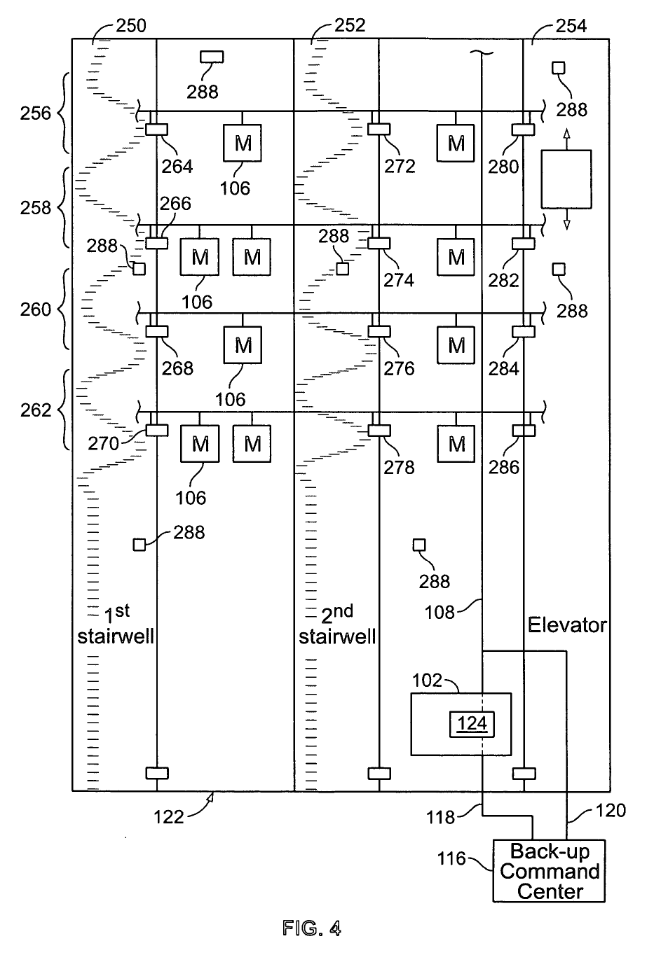

Muster stations 106 are located throughout the building 122. Each of the muster stations 106 may be connected to the MSCM 104 with the first communication link 108. Each muster station 106 is given a unique address, such as an IP address, which may be used when communicating over the first communication link 108. Additional communication links may be used to ensure communication during an emergency. For example, the second communication link 110 may be routed through different areas of the building 122 and also provide communication between the MSCM 104 and the muster stations 106. The second communication link 110 may be hardwired, such as a LAN, WAN, or other wired network, or may be wireless, using a network of wireless routers (FIG. 4) which are installed in the building 122.

By way of example, muster stations 106 on line 130 may be located on a 50^{th} floor of the building 122. Similarly, muster stations 106 on lines 132, 134 and 136 may be located on 45^{th}, 40^{th}, and 35^{th} floors, respectively. The number of muster stations 106 on a particular floor may be determined by the number of employees assigned to work on the floor, by the size of the work areas on the floor, or by specific needs of employees in a location. For example, one muster station 106 may be provided for every group of 20 employees.

A back-up command center 116 may be in communication with the command module 124 of the MSCM 104 and the muster stations 106 by way of third and/or fourth communication links 118 and 120. The back-up command center 116 may be located at a different location within the building 122 or off-site, such as at a local fire station or other emergency or monitoring station. The back-up command center 116 may provide all or a portion of the functionality of the MSCM 104. Therefore, the back-up command center 116 provides redundant monitoring and information distribution capability in the event that the MSCM 104 is partially or completely disabled, or if the main command center 102 is evacuated or inaccessible. The back-up command center 116 may increase the efficiency, both in time and substance, as emergency responders in the back-up command center have access to specific and current information regarding the emergency situation.

The first, second, third and fourth communication links 108, 110, 118 and 120 may be separate networks with respect to each other, and separate from any other phone, data, video, wireless or wired networks within the building 122. Thus, the first and second communication links 108 and 110 may be dedicated such that both are only used for communications between the main command center 102 and muster stations 106, while the third and fourth communication links 118 and 120 may be dedicated such that both are only used for communications between the back-up command center 116, the main command center 102 and the muster stations 106. The communications links 108, 110, 118 and 120 may be bi-directional and convey voice, data packets, video, and the like, such as by using known networking protocols. Alternatively, the communications links 108, 110, 118 and 120 may share one or more component amongst themselves and/or with other new or existing wiring or wireless infrastructure.

FIG. 2 illustrates an integrated system 140 for monitoring events and communicating emergency information. The integrated system 140 integrates the communication capabilities of the system 100 (FIG. 1) with an alarm detection system 144. The MSCM 104 and a fire alarm control panel (FACP) 14 may both be located within the main command center 102 and communicate with each other over line 142. Alternatively, the MSCM 104 and FACP 14 may be integrated, sharing control panels, control modules, and displays, for example.

The FACP 14 monitors one or more detector networks 12 within the alarm detection system 144 having individual alarm condition detectors 32. The detectors 32 may detect fire, smoke, temperature, chemical compositions, or other conditions. The alarm condition detectors 32 are coupled across a pair of power lines 34 and 36. When an alarm condition is sensed, the FACP 14 signals the alarm to the appropriate notification devices through one or more networks 16 of addressable notification appliances 24 and/or one or more networks 22 of hardwired (e.g. non-addressable) alarm notification appliances 26. The networks 16 and 22 may also be referred to as notification appliance circuits (NAC).

The addressable notification appliances 24 are coupled to the FACP 14 across a pair of lines 18 and 20 that are configured to carry power and communication, such as command instructions. The notification appliances 24 each have a unique address and both send and receive communications to and from the FACP 14. Therefore, the addressable notification appliances 24 may communicate their status and functional capability to the FACP 14 over the lines 18 and 20. The hardwired notification appliances 26 are coupled with the FACP 14 across a pair of lines 28 and 30. A notification signal sent on the network 22 from the FACP 14 will be received by each hardwired notification appliance 26. An end of line (EOL) device 38 interconnects the ends of the lines 28 and 30 opposite the FACP 14.

The FACP 14 is connected to a power supply 40 which provides one or more levels of voltage to the system 10. The power supply 40 may be an AC branch circuit. One or more batteries 42 may provide a back-up power source for a predetermined period of time in the event of a failure of the power supply 40 or other incoming power. Other functions of the FACP 14 include displaying the status of the alarm detection system 144 and/or installed components, resetting a part or all of the alarm detection system 144, such as silencing signals and turning off strobe lights.

The FACP 14 has a control module 44 which provides control software and hardware to operate the alarm detection system 144. An input/output (I/O) port 46 allows communication with external devices such as a laptop computer. Alternatively, the FACP 14 may have wireless capability, allowing wireless communication between the FACP 14 and the external device.

The control module 44 and command module 124 of the FACP 14 and MSCM 104, respectively, share data, communications, and status information over the line 142. The control module 44 and command module 124 may monitor and correlate data to provide emergency information to an emergency responder, such as whether a particular stairwell is safe to use during a fire.

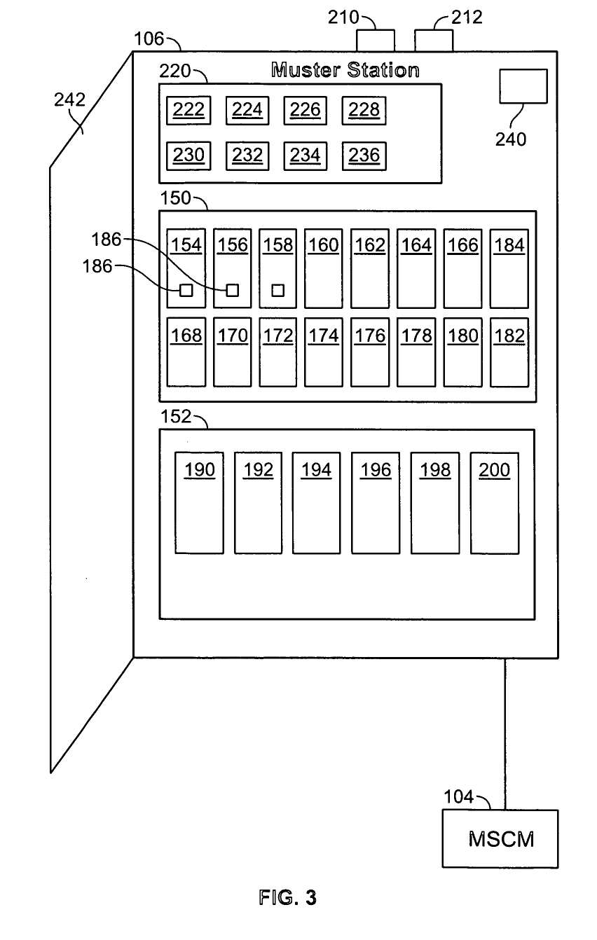

FIG. 3 illustrates a muster station 106 in accordance with an embodiment of the present invention. The muster station 106 may be a stand-alone unit, or may be contained within a wall opening, such as a closet or fire extinguisher compartment. The muster station 106 may be fire proof, fire resistant, and/or reinforced to withstand great force, such as an explosion.

One or more cavities 150 and 152 within the muster station 106 hold and organize emergency equipment and supplies. The cavities 150 and 152 may be, for example, shelves, bins, boxes, or a combination thereof. Equipment useful in a variety of emergencies may be stored in the cavities 150 and 152 for use by both people on the floor and emergency responders. By way of example, in the cavity 150, one or more of the following may be stored: a radio 154, cell phone 156, flashlight 158, portable video camera 160, emergency smoke masks 162, defibrillator 164, first aide kit 166, personal locator devices 168, fire extinguisher 170, building egress maps 172, telephone 174, portable communication devices 176 such as a pager, walkie-talkie, or personal digital assistance, infrared video camera 178, heat shielding blanket 180, a fire fighter phone 182, written or printed emergency information 184 such as emergency instructions and checklists, lists of phone numbers and personnel rosters. In addition, the muster station 106 may store bottled water and non-perishable food.

The type and quantity of equipment and supplies may be based on the number of people the muster station 106 is expected to provide for, such as 20 or 30 people. Each muster station 106 is designed to accommodate people assigned to the respective muster station 106 as well as transients such as guests and visitors in the area. The people mustering at a particular muster station 106 may be referred to herein as a muster group. One benefit of mustering or grouping at a muster station 106 is that emergency training for building residents and visitors is very simple. The assigned people are instructed to proceed to the muster station 106 in an emergency or when so directed. The assigned people bring along any guests or transients in the area. Therefore, each person does not need to know all of the emergency procedures as the procedures are disseminated to the muster group at the muster station 106. In addition to simplifying emergency training, mental and emotional comfort is provided to the building occupants with respect to emergency preparedness.

The portable communication devices 176 may be limited to work on one or more predetermined frequencies and/or networks to prevent unauthorized use and/or conflict with other communication devices. The portable communication devices 176 may be limited to allow communication only with the main and back-up command centers 102 and 116 over the dedicated first and second communication links, or may allow access to other networks, such as any cellular or other wireless networks providing service to the building 122.

The command centers 102 and 116 may use the communications devices 176 to communicate with muster groups rather than with individuals. Managing a smaller number of muster groups greatly simplifies the command centers' communications by reducing their load primarily to the muster groups. Optionally, the muster groups may have pre-assigned names and known locations, such as 45-A for floor 45 muster group A, which may further simplify the command center personnel's information management task. Other naming schemes may be used. In contrast, the management of individuals quickly becomes unwieldy, as each name and location, which may be provided with a non-standard location description, would have to be recorded, and individuals may use a broad variety of communications devices.

The cavity 152 may also be used to store back-up equipment and tools that an emergency responder may need, such as oxygen masks 190, air bottles 192, oxygen bottles 194, fire water hose 196, fire fighter phone 198, and foam extinguishing canisters 200. It should be understood that many kinds of equipment and tools may be useful during an emergency, and therefore other items and communication equipment and devices may be provided. Alternatively, back-up equipment such as the air bottles 192 and oxygen bottles 194 may be stored on every other floor or every five floors, for example. The cavity 152 creates a cache of supplies which may be increasingly useful on higher floors as equipment typically is personally transported by the emergency responder. For example, the emergency responder may be able to remain longer in an area by having access to a spare air bottle 192.

A control panel 220 is within or near the muster station 106. The control panel 220 may provide communication between the muster station 106 and the command module 124 at the main command center 102 and/or the back-up command center 116 over the first communication link 108. A request from the control panel 220 to establish communication may be directed to either the main or back-up command centers 102 and 116 based on a hierarchical protocol, or to both in parallel. The main command center 102 may manually or automatically reroute a request from a muster station 106 based on volume of requests, availability of personnel at the main command center 102, or the nature of the emergency, for example.

When an emergency situation is detected, a visual indicator 210 and/or an audible indicator 212 may be activated, locally or from the main or back-up command centers 102 and 116, to alert people in the area to the situation. The visual indicator 210 may be a strobe while the audible indicator 212 may output a horn or bell sound, a prerecorded message, or act as a loud speaker for current voice commands from the main command center 102 or a person at the muster station 106. The visual and audible indicators 210 and 212 may be controlled by an indicator activation signal from the command module 124 of the main command center 102, or may be activated and deactivated by a button or switch 222 on the control panel 220 at the muster station 106.

The control panel 220 may also have a communication input such as a phone port 224 accepting the fire fighter phone 182 or 198 to provide a direct phone connection to the main command center 102 and/or the back-up command center 116 over the first communication link 108. When a fire fighter phone 182 or 198 is plugged into the phone port 224, the control panel 220 sends a request to initiate communication to the command module 124 at the main command center 102. The indicator (as previously discussed) is activated, such as on the display 126. A communication initiation switch 236 may also be used to initiate communication between the muster station 106 and the MSCM 104, such as by providing an indication at the display 126 (FIG. 1). A video port 226 accepts input from the portable video or infrared video cameras 160 and 178 to communicate live information to emergency responders in the main command center 102 so that the situation may be better accessed.

An antenna 228 and one or more wireless hubs 230 may be included to facilitate the use of the portable communication devices 176 as people move about the building 122. The wireless hubs 230 may be transmitters/receivers, switches or other devices with wireless capability known in the art, and may be powered by AC power, such as power supply 112 (FIG. 1), as well as battery back-up, such as battery 114. The wireless hubs 230 may be part of the first or second communication links 108 and 110, or separate, forming an alternate network.

A switch or sensor 240 may sense when a door 242 enclosing the muster station 106 is opened. The control panel 220 then sends an open door notification signal to the command module 124 of the MSCM 104. The open door notification signal includes identification of the muster station 106 and may indicate that an emergency situation exists which has not otherwise been detected by the system 140, such as a heart attack, or may alert authorities to an unauthorized access to the muster station 106.

The personal locator devices 168 may be radio frequency identification (RFID) tags, for example, or other technology applicable to outputting a locator signal. The locator devices 168 may be active and stored in the muster station 106 in one or more containers that inhibit an RFID reader (such as reader 234) from reading or sensing the locator devices 168. Once the locator devices 168 are removed from the containers, the locator devices 168 are automatically read by one or more local RFID reader. Alternatively, the locator devices 168 may be manually activated in an emergency, such as by holding the locator device 168 to an activation sensor 232 on the control panel 220, by a switch or button on the locator device 168, by a signal initiated in response to opening the door 242, or any other activation method.

One locator device 168 is then worn or carried by each person within the muster group. For example, a locking wrist strap may be provided to ensure that the locator device 168 stays with the person. Alternatively, a locator device 168 may be attached to each employee badge or wrist strap, wristwatch or similar device, or each visitor may be given a badge with an attached locator device 168.

Tracking sensors 186 may be installed on equipment such as the radio 154, cell phone 156 and flashlight 158, and may also be RFID tags. The tracking sensors 186 allow tracking of equipment and/or personnel by communicating through the wireless hub 230. The tracking sensors 186 allow emergency responders to determine availability and location of equipment on a particular floor, and also to track progress of personnel as they move within the building 122.

A reader 234 on the control panel 220 detects the locator devices 168 and tracking sensors 186 within a predetermined radius of the muster station 106. The reader 234 may also detect the locator devices 168 and tracking sensors 186 during a test or maintenance operation. The locator devices 168 and tracking sensors 186 may be programmed to communicate origination information identifying a particular floor or muster station 106.

FIG. 4 illustrates an emergency communication and tracking system within the building 122 using the system 140 (FIG. 2) in accordance with an embodiment of the present invention. First and second stairwells 250 and 252 and an elevator 254 are illustrated, and may collectively be referred to as egress corridors. It should be understood that within a large building 122 such as a high rise, there are many stairwells and banks of elevators which would be available and monitored. In addition, the building 122 may have long corridors or tunnels (not shown), as well as emergency exits, all of which may be monitored. The main command center 102 and back-up command center 116 are interconnected with the muster stations 106 located on, by way of example only, 50^{th}, 45^{th}, 40^{th} and 35^{th} floors 256, 258, 260 and 262, respectively.

A reader 264-278 is located at or near each door to the first and second stairwells 250 and 252. The readers 264-278 detect the locator devices 168 and tracking sensors 186 to track people and equipment nearby, entering, leaving and moving through the first and second stairwells 250 and 252. A reader 280-286 is located at or near each elevator door to detect and track people and equipment nearby, entering, leaving and riding in the elevator 254. The readers 234 (FIG. 3) at the muster stations 106, the readers 264-286, together with any readers installed on a floor, an egress corridor, door, or other area form a reader network which may be in wired communication with the first communication link 108 (FIG. 1). Alternatively, the readers 234 and 264-286 may be wireless or a combination of wired and wireless. Wireless hubs 288 are installed in the first and second stairwells 250 and 252 and the elevator 254, as well as other areas within the building 122, to allow wireless communication with emergency responders in the main command center 102 and/or back-up command center 116.

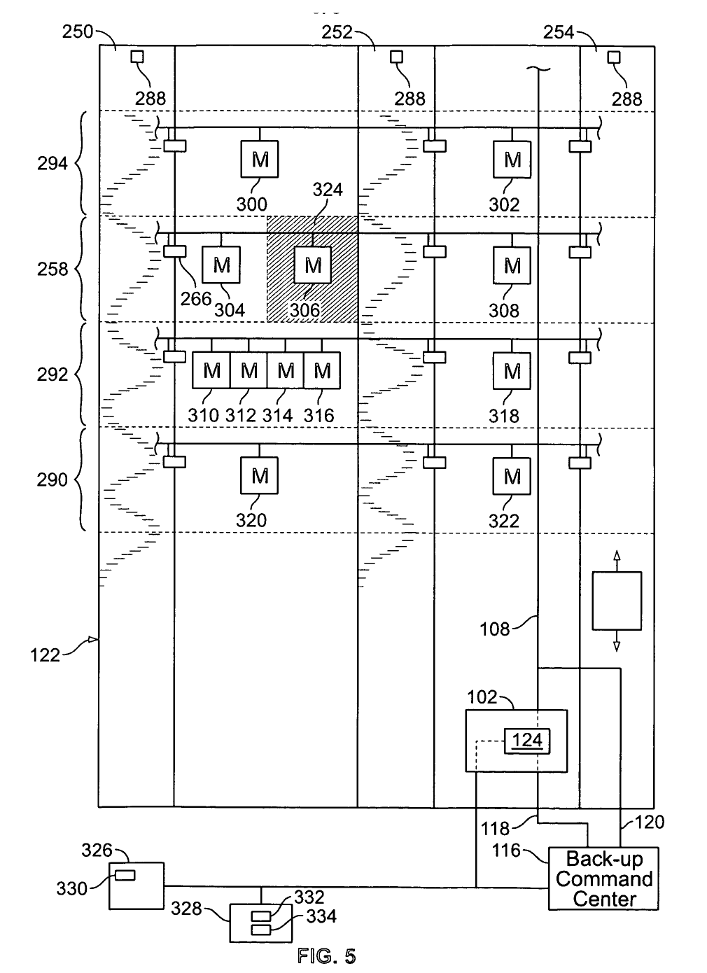

FIG. 5 illustrates a portion of the emergency communication and tracking system (FIG. 4) in accordance with an embodiment of the present invention. The 45^{th} floor 258 is indicated, as well as 43^{rd}, 44^{th} and 46^{th} floors 290, 292 and 294. Muster stations 300 and 302 are located on the 46^{th} floor 294, muster stations 304, 306 and 308 are on the 45^{th} floor 258, muster stations 310, 312, 314, 316 and 318 are on the 44^{th} floor 292, and muster stations 320 and 322 are on the 43^{rd} floor 290. By way of example, the 44^{th} floor 292 may have more employees and therefore five muster stations 310-318 are used, while the number of employees on the 43^{rd} floor 290 is less and only two muster stations 320 and 322 are needed.

The emergency communication and tracking system may be used together with emergency/disaster preparedness and evacuation plans determined for the building 122. For example, the MSCM 104 may be programmed to store suggested action trees that are displayed to emergency responders on display 126 in the main command center 102. The action trees may be launched based on key combinations, voice commands, or emergencies detected by the MSCM 104 or FACP 14. Alternatively, the command module 124 of the MSCM 104 may automatically output a series of commands to the main command center 102 and one or more of the muster stations 106 based on type and location of an emergency situation.

By way of example, an alarm condition detector 32 (FIG. 2) on a detector network 12 on the 45^{th} floor 258 of the building 122 may detect and report a smoke/fire condition within an area 324. The addressable and/or hardwired notification appliances 24 and 26 located on the 45^{th} floor 258 may be activated by the control module 44 of the FACP 14 to chime or strobe. In addition, the FACP 14 may communicate the condition to the MSCM 104 over line 142 (FIG. 2). The FACP 14 and MSCM 104 know the location of the alarm condition detector(s) 32 which have detected the event, and this information may be used when determining what action, if any, should be taken.

The MSCM 104 may activate the visual and/or audible indicators 210 and 212 (FIG. 3) at the muster stations 304, 306 and 308 on the 45^{th} floor 258, notifying personnel to muster or gather at the closest muster station or their assigned (or primary) muster station. The visual and/or audible indicators 210 and 212 at the muster stations 106 on surrounding floors, such as the 44^{th} and 46^{th} floors may also be activated. As muster station 306 is within the area 324, personnel may be directed to either muster station 304 or 308.

At the muster station 304, the control panel 220 senses the sensor 240 (FIG. 3) when the door 242 is opened. The control panel 220 sends the open door notification signal to the command module 124 of the MSCM 104. A user, such as a group leader, may plug the fire fighter phone 182 into the phone port 224 to gain direct contact to the MSCM 104 and emergency responders in the main command center 102. Alternatively, the group leader may activate the communication initiation switch 236 to initiate communication with the main command center 102, providing or requesting updated information. As discussed previously, indicators at the MSCM 104 are activated by the command module 124, identifying which muster station is calling. Group leaders may determine if everyone assigned to the muster group is accounted for to limit the amount of searching for personnel, and this information may be communicated over the first communication link 108 to the command module 124 at the main command center 102.

The locator devices 168 are activated (if necessary) and distributed to people in the muster group. The emergency responders in the main command center 102 may inform the muster group at the muster station 304 that they must evacuate via the first stairwell 250 as it may not be safe to access the second stairwell 252 from their location. The muster group at the muster station 308 may be directed to use the second stairwell 252 as their access to the first stairwell 250 is blocked by the hazard in area 324. The group leader may connect the portable video or infrared video camera 160 and 178 to the video port 226 on the control panel 220 of the muster station 304, relaying video of the emergency situation to the display 126 of the MSCM 104 over one of the first and second communication links 108 and 110. This may allow the emergency responders to better access the situation and thus provide better assistance.

Both muster groups may be directed to take specific equipment, such as the cell phone 156, flashlight 158, emergency smoke masks 162, and egress maps 172. The emergency responders in the main command center 102 can provide further instruction on how to use the necessary equipment. The emergency responders may direct the groups of people to take different actions, such as go down the first or second stairwells 250 or 252 to the 40^{th} floor 260. It may not be necessary to have the groups of people evacuate the building 122, but rather relocate to a safe location. Communication is made possible by the fire fighter phone 182, cell phone 156 and other portable communication devices 176, such as over the wireless hubs 288. Alternatively, emergency responders may direct all groups to continue down the first or second stairwell 250 or 252 and exit the building 122, exit at a particular floor and wait for further instruction, or to take the elevator 254 to a specific location. The elevator 254 is typically not available during emergency situations affecting the building 122, but the integrated system 140 may help emergency responders determine whether it is safe to use. The wireless hubs 288 in the first and second stairwells 250 and 252 and the elevator 254 provide direct communication to the command module 124 at the main command center 102 and/or the back-up command center 116.

As people exit the 45^{th} floor 258 into the first stairwell 250, the reader 266 detects the locator devices 168 carried by each person and the tracking sensors 186 attached to equipment. The location of each locator device 168 and tracking sensor 186 may be displayed on the display 126 (FIG. 1) at the main command center 102, such as by a dot or blinking colored light. Therefore, emergency responders can track people and equipment to determine if they stay together as a group and go to the designated location. If someone becomes separated from the group, the display 126 can track if they have been left behind, have continued down the stairwell, or strayed from the group. This information can be communicated to the group leader, as necessary, such as over the wireless hubs 288 to the cell phone 156.

By tracking the locator devices 168, emergency responders may know the locations of people who are trapped (such as in a locked stairwell), have become incapacitated, or otherwise cannot get themselves out of the building 122. Also, the command module 124 of the MSCM 104 can track how many people are accounted for and where they are located within the building 122 to determine if emergency responders need to rescue and/or search for people. The command module 124 may further track how many people have evacuated the building 122. This information may be displayed on the display 126 in a variety of ways, such as by the entire building 122, by floor, or by stairwell.

Muster groups on the 46^{th} and 44^{th} floors 294 and 292 may be given different instructions from muster groups on the 45^{th} floor 258. Groups of people may gather at each of the muster stations 300, 302 and 310-318 and wait for further instruction from the main command center 102. On the 46^{th} floor 294, a group leader at each of the muster stations 300 and 302 may contact the main command center 102 to report the number of people in their group and receive instructions. Locator devices 168 and other safety equipment which may be needed are distributed. The groups at the muster stations 300 and 302 may be directed to evacuate to a designated lower floor using only the first stairwell 250.

On the 44^{th} floor 292, the group leader at each of the muster stations 310-318 may contact the main command center 102, report the number of people in their group, receive instructions and distribute locator devices 168 and/or equipment. If an immediate evacuation is not necessary, the groups at the muster stations 310-318 may be told to wait at the muster stations 310-318 until emergency responders have determined, such as by monitoring the movement of the locator devices 168, that enough room is available in the first and second stairwells 250 and 252. Communication between the main command center 102 and the muster stations 106 and/or portable communication devices 176 allows current and accurate information to be communicated in a timely manner.

If an emergency situation or event occurs, or threatens to occur, necessitating an evacuation of most or all of the people within the building 122, the main command center 102 may activate the muster stations 106 in an orderly fashion to avoid clogging the first and second stairwells 250 and 252, avoid misinformation, attempt to control hysteria and panic, and facilitate a safe evacuation. Groups may gather and be accounted for at their respective muster stations 106, activate their locator devices 168, and evacuate the building 122 as a group. The readers 234 and 264-286 track the locator devices 168 and tracking sensors 186, and emergency responders can determine how many people are still in the building 122, determine if there is a problem with the evacuation, redirect a group to a different stairwell or location if necessary, and clear a stairwell for emergency responder use or in response to a change in the emergency situation.

The command module 124 of the MSCM 104 may patch together one or more muster stations 106 over one of the first and second communication links 108 and 110 to facilitate an exchange of information, such as over the fire fighter phones 182 or 198. This function may be desirable when emergency responders are located at a first location, such as muster station 308, and a muster group is at a second location, such as muster station 306, which is not easily or quickly accessible from the first location.

Communication is also facilitated between the command module 124 of the main command center 102 and emergency responders' personal equipment, such as helmet heat sets and two-way communication devices. Emergency responders may also be equipped with locator devices 168 to monitor their location.

Remote check-in stations 326 and 328 (FIG. 5) may be provided for situations in which people leave the building 122 in a disorderly fashion, or may be used to account for people who were outside the building 122 during the evacuation. The remote check-in stations 326 and 328 may be located a distance from the building 122 which has been determined to be a likely safe distance in the event of an emergency, but may also be within walking distance. If the locator devices 168 have been activated and distributed, a person may need only to pass by a reader 330, similar to the readers 264-286 installed in the first and second stairwells 250 and 252. The reader 330 detects the locator device 168, which may be transmitting further information such as the muster station 106 or floor where the locater device 168 was activated or originally stored. Alternatively, a keyboard 332 may be provided to enter data or a keycard reader 334 for swiping an employee badge, for example. The remote check-in stations 326 and 328 may save information to a server located in the same or a different location, and may accept input over the internet, allowing a building occupant to inform the main command center 102 that they are safely out of the building 122 from any internet connection.

It should be understood that the system 100 (FIG. 1) and the integrated system 140 (FIG. 2) may be used in other enclosed areas, such as a mine or other below ground facility, and in facilities which have a large horizontal and/or vertical square footage and may include multiple separate buildings. For example, the systems 100 and 140 may be useful in hospital environments where it is difficult to transport patients and the presence of visitors make it difficult to determine if an area has been cleared. In this situation, a greater quantity of locator devices 168 may be stored in the muster stations 106 while hospital personnel act as group leaders for visitors and patients.

While the invention has been described in terms of various specific embodiments, those skilled in the art will recognize that the invention can be practiced with modification within the spirit and scope of the claims.

What is claimed is:

1. A system for providing emergency communication within a building, comprising:
a command center;
a command module located at the command center;
control modules located at respective muster stations located in different areas within a building; and
at least one communication link providing communication between the command module at the command center and each of the control modules at the muster stations.

2. The system of claim 1, the control modules each further comprising at least one of a communication initiation switch and a communication device input port, the control panel sending a request to initiate communication to the command module at the command center over the at least one communication link when either the communication initiation switch is activated or a communication device is plugged into the communication device input port.

3. The system of claim 1, the command module at the command center further comprising an indicator for identifying a muster station and indicating that a user at the muster station is initiating communication over the at least one communication link.

4. The system of claim 1, further comprising:
the at least one communication link further comprising wireless hubs located within the building providing wireless communication to and from the command module at the command center; and
wireless communication devices stored proximate the muster stations, the wireless hubs providing wireless communication between the wireless communication devices and the control module.

5. The system of claim 1, further comprising:
a locator device stored proximate the muster station; and
readers installed within the building for detecting the locator device, the readers being connected to the at least one communication link, the readers providing a location of the locator device to the command module of the command center over the at least one communication link.

6. The system of claim 1, the command center further comprising at least one of a first command center located in the building and a second command center located outside the building.

7. The system of claim 1, wherein the muster stations are each assigned a unique address, the unique address identifying communication sent to and from each of the muster stations over the at least one communication link.

8. The system of claim 1, each of the muster stations further comprising:
a door enclosing the muster station; and
at least one of a switch and a sensor detecting when the door is open, the control module providing an open door notification signal over the at least one communication link to the command module at the command center, the open door notification signal identifying the respective muster station.

9. A muster station for communicating with a command module at a command center during emergency situations, comprising:
a control module at a muster station for providing communication with a command module located at a command center;
a communication link connecting the control module at the muster station with the command module at the command center; and
a communication device communicating through the control module with the command module, the communication link providing two-way communication between the command module and the communication device over the communication link.

10. The muster station of claim 9, the control module further comprising an input port accepting input from at least one of a fire fighter phone, a telephone, and a video camera.

11. The muster station of claim 9, the communication link further comprising means for wireless communication between the control module at the muster station and the command module at the command center.

12. The muster station of claim 9, the control module further comprising at least one of an audible indicator and a visual indicator for alerting people to an emergency situation, the at least one of an audible and visual indicator being controlled by signals from the command module at the command center over the communication link.

13. The muster station of claim 9, further comprising:
at least one of a locator device and a tracking sensor stored proximate the muster station; and
a reader installed in the control module for detecting the at least one of a locator device and tracking sensor, the reader providing a location of each of the at least one of a locator device and tracking sensor to the command module of the command center over the communication link.

14. The muster station of claim 9, the control module further comprising means for initiating communication with the command module at the command center.

15. A system for tracking moving objects within an area and communicating emergency information, comprising:
a command module located at a command center;
control modules located at respective muster stations provided within the area;
a communication link interconnecting the command module at the command center and the control modules at the muster stations, the communication link providing communication between the command module and the control modules; and
readers detecting location information of locator devices and tracking sensors, the readers being connected to the communication link and providing the location information to the command module of the command center over the communication link.

16. The system of claim 15, the communication link transmitting at least one of voice signals, data packets and video signals between the command module at the command center and the control modules at the muster stations.

17. The system of claim 15, the communication link providing a dedicated connection between the command module at the command center and the control modules at the muster stations.

18. The system of claim 15, the command center further comprising a display, the command module displaying a suggested action tree on the display based on data indicative of an emergency situation.

19. The system of claim 15, further comprising:
an alarm detection system detecting emergency situations; and
a second communication link interconnecting the alarm detection system and the command module at the command center, the alarm detection system providing information about detected emergency situations to the command module.

20. The system of claim 15, further comprising a second command center located remote with respect to the command center, the communication link interconnecting the second command center to the command center.
